(19) United States
(12) Patent Application Publication
(10) Pub. No.: US 2012/0290937 A1
(43) Pub. Date: Nov. 15, 2012

(54) DISTRIBUTION OF MEDIA TO MOBILE COMMUNICATION DEVICES

(75) Inventor: LEIGH M. ROTHSCHILD, SUNNY ISLES BEACH, FL (US)

(73) Assignee: LMR INVENTIONS, LLC, SUNNY ISLES BEACH, FL (US)

(21) Appl. No.: 13/106,473

(22) Filed: May 12, 2011

(51) Int. Cl. G06F 15/16; G06F 3/048

(52) U.S. Cl. 715/738; 709/219

(57) ABSTRACT

A method of delivering media to mobile communication devices and a media server that delivers media to mobile communication devices. Via the media server, selected media can be collected via a communication network and the selected media can be stored to a computer readable storage device. A presence of a mobile communication device can be detected on a private network serviced by the media server and information relating to the selected media can be sent to the mobile communication device. Responsive to receiving from the mobile communication device a selection of at least one media presentation from the selected media, the media presentation can be provided to the mobile communication device.

### BACKGROUND

The embodiments disclosed within this specification relate to distribution of media. More particularly, the embodiments relate to location specific delivery of media selected for a particular establishment.

The use of the Internet as a communication medium to distribute media continues to grow. The bandwidth available to users oftentimes is limited, however. For example, users of mobile communication devices sometimes rely on relatively low bandwidth cellular networks for Internet connectivity. The delivery of media, especially video, over such connections is far from seamless. Indeed, when video media is streamed over a cellular network, the data delivery rate oftentimes is insufficient to keep up with the presentation rate of the video media, thus resulting in unwanted pauses during the video presentation.

A growing trend among many businesses is to provide on-site WiFi™ Internet connectivity to their customers who use mobile communication devices. In a typical scenario, a wireless access point is provided at the establishment, and connected to the Internet via a wired Internet connection, such as a T-1 line, a DSL line, or cable connection. Although the use of WiFi™ generally provides greater bandwidth in comparison to a cellular network, the user experience typically is not seamless. In illustration, when multiple customers concurrently attempt to access media via the Internet, the limits of the bandwidth available via the establishment's Internet connection may be quickly reached, again resulting in pauses during presentation of the media.

### BRIEF SUMMARY

The embodiments disclosed within this specification relate to delivering media to mobile communication devices. One embodiment of the present invention can include a method of delivering media to mobile communication devices. The method can include, via a media server, collecting selected media via a communication network and storing the selected media to a computer readable storage device. The method also can include detecting a presence of a mobile communication device on a private network serviced by the media server and sending to the mobile communication device information relating to the selected media. The method further can include, responsive to receiving from the mobile communication device a selection of at least one media presentation from the selected media, providing the media presentation to the mobile communication device.

Another embodiment of the present invention can include a media server that delivers media to mobile communication devices. The media server can include at least one memory device and at least one processor. The processor can be operable to collect selected media via a communication network and store the selected media to a computer readable storage device. The processor also can be operable to detect a presence of a mobile communication device on a private network serviced by the media server and send to the mobile communication device information relating to the selected media. The processor further can, responsive to receiving from the mobile communication device a selection of at least one media presentation from the selected media, provide the media presentation to the mobile communication device.

Yet another embodiment of the present invention can include a computer program product including a computer readable storage medium having stored thereon computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for delivering media to mobile communication devices in accordance with one embodiment of the present invention.

FIG. 2 is a block diagram illustrating a system for delivering media to mobile communication devices in accordance with another embodiment of the present invention.

FIG. 3 is a flow chart illustrating a method of delivering media to mobile communication devices in accordance with another embodiment of the present invention.

FIG. 4 is a flow chart illustrating a method of delivering media to mobile communication devices in accordance with another embodiment of the present invention.

FIG. 5 is block diagram illustrating a media server in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including (irmware, resident software, micro-code, etc.) or an embodiment combining software and hardware aspects that may all generally be referred to herein as a “circuit,” “module” or “system,” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage device. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: a portable computer diskette, a hard disk drive (HDD), a solid state drive (SSD), a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer readable storage device may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage device and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention relates to the collection of selected media by a media server of an establishment (e.g., restaurant, coffee shop, store, etc.), for example via the Internet, and the communication of the selected media to the mobile communication devices of patrons of the establishment. The media that is selected for collection can be media likely to be of interest to the patrons of the establishment. Moreover, when a mobile communication device connects to the establishment's private network, the mobile communication device can be detected by the media server, and a selection menu can be pushed, or automatically sent, to the communication device. From the selection menu, a user, such as a patron of the establishment, can select one or more media presentations to be presented on the mobile communication device.

Because the media is stored on the establishment's media server, the media presentations can be streamed, downloaded, or otherwise delivered to, mobile communication devices without experiencing delays that otherwise may occur if the media presentations were accessed directly from the media provider over the Internet. Moreover, the media server can communicate the media presentations to the mobile communication devices using any of a myriad of suitable communication mediums, which will be described herein.

As used herein, the term “media” means audio, video, audio/video, photographs and/or text media. The media may be stored in a digital format. As used herein, a “media presentation” is a contiguous media presentation, for example a single news broadcast, a single television show, a single photo or photo album, a single text presentation, etc. A contiguous media presentation may be divided into different portions. For example, in the case of a news broadcast or other television program, a contiguous media presentation may comprise different scenes, or portions between which commercials were provided.

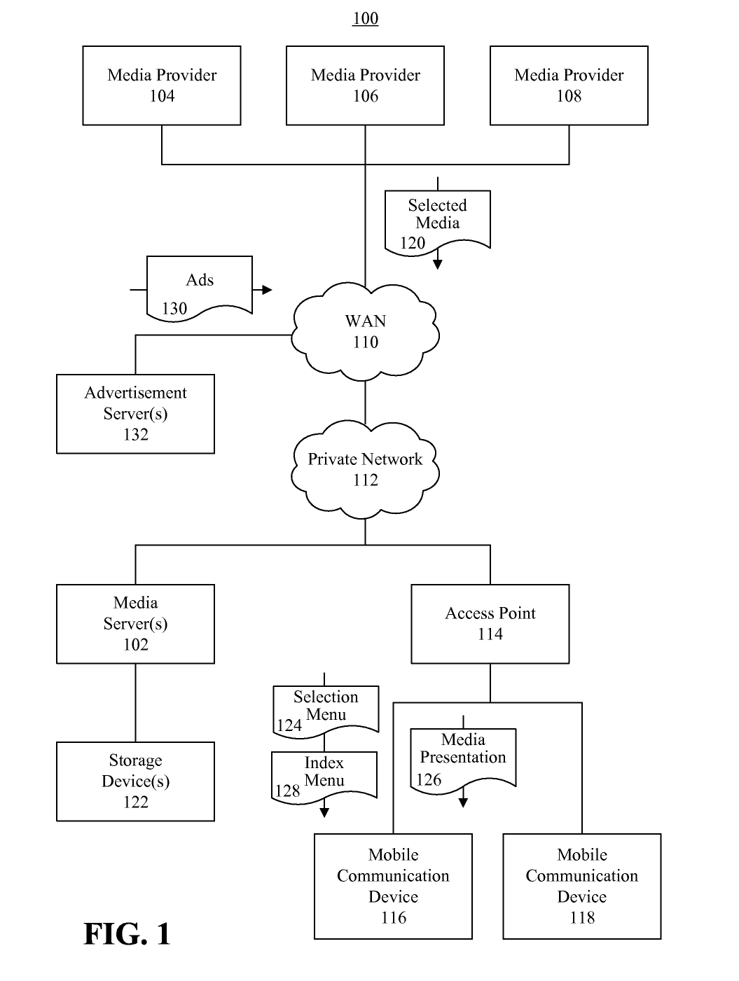

FIG. 1 is a block diagram illustrating a system 100 for delivering media to mobile communication devices in accordance with one embodiment of the present invention. The system can include one or more media servers 102 that are configured to communicatively link to one or more media providers 104, 106, 108, for example via a WAN 110. The media providers 104-108 can comprise, for example, one or more servers that distribute media. In one arrangement, the media server(s) 102 can connect to the WAN 110 via a private network 112, though this need not be the case. The WAN 110 can include, for example, the Internet. The private network 112 can be a LAN, a wireless LAN (WLAN), a personal area network (PAN), or any other suitable localized network.

The system 100 further can include an access point 114 operable to provide to one more mobile communication devices 116, 118 network connectivity to the private network 112. Examples of the mobile communication devices 116, 118 can include, but are not limited to, notebook computers, laptop computers, netbook computers, tablet computers, personal digital assistants, mobile telephones (e.g., smartphones), portable gaming devices, and the like. Examples of presently available smartphones include, but are not limited to, the Apple® IPhone®, smartphones based on the Google™ Android™ operating system, mobile telephones based on the Windows® Phone operating system, and BlackBerry® Smartphones. Notwithstanding, the present invention is not limited to these examples.

In one arrangement, the access point 114 can comprise a wireless transceiver. For example, the access point 114 can comprise a wireless access point, a wireless router, a PAN transceiver, an infrared transceiver, a cellular communications transceiver, or any other wireless transceiver that may be used to provide wireless communication links between the media server 102 and the mobile communication devices 116, 118.

In an arrangement in which the access point 114 comprises a wireless access point or a wireless router, the access point 114 can be configured to communicate with the mobile communication devices 116, 118 via IEEE 802 wireless communications, for example 802.11, 802.16 (WiMax), WiFi™, WiFi™ Protected Access (WPA), WPA2, or another suitable wireless LAN communication protocol. In an arrangement in which the access point 114 comprises a PAN transceiver, the access point 114 can be configured to communicate with the mobile communication devices 116, 118 via Bluetooth®, ZigBee™ or another suitable PAN protocol. In an arrangement in which the access point 114 comprises an infrared transceiver, the access point 114 can be configured to communicate via the Infrared Data Association (IrDA) standard protocol or another suitable infrared communication protocol. In an arrangement in which the access point 114 comprises a cellular communications transceiver, the access point 114 can be configured to communicate in accordance with one or more of TDMA, CDMA, WCDMA, GSM, UMTS, GPRS, RAN, UMB, OFDM, 3G, 4G, LTE or any another suitable cellular communication protocols or standards.

The access point 114 also may comprise a wired router, a switch, a hub or any other device or devices that communicate with the communication devices 116, 118 via wired communication links. In an arrangement in which the access point 114 comprises a wired router or switch, the access point 114 can be configured to communicate via Ethernet or another suitable wired LAN communication protocol. In an arrangement in which the access point 114 comprises a hub, the access point 114 can be configured to communicate via the universal serial bus (USB) protocol, the IEEE-1394 (Firewire®) protocol, the serial ATA (SATA) protocol, the Thunderbolt™ protocol, or another protocol that supports wired communication links between the media server 102 and the mobile communication devices 116, 118. Still, the access point 114 can be configured to communicate with the mobile communication devices 116, 118 in any other suitable manner and the invention is not limited in this regard.

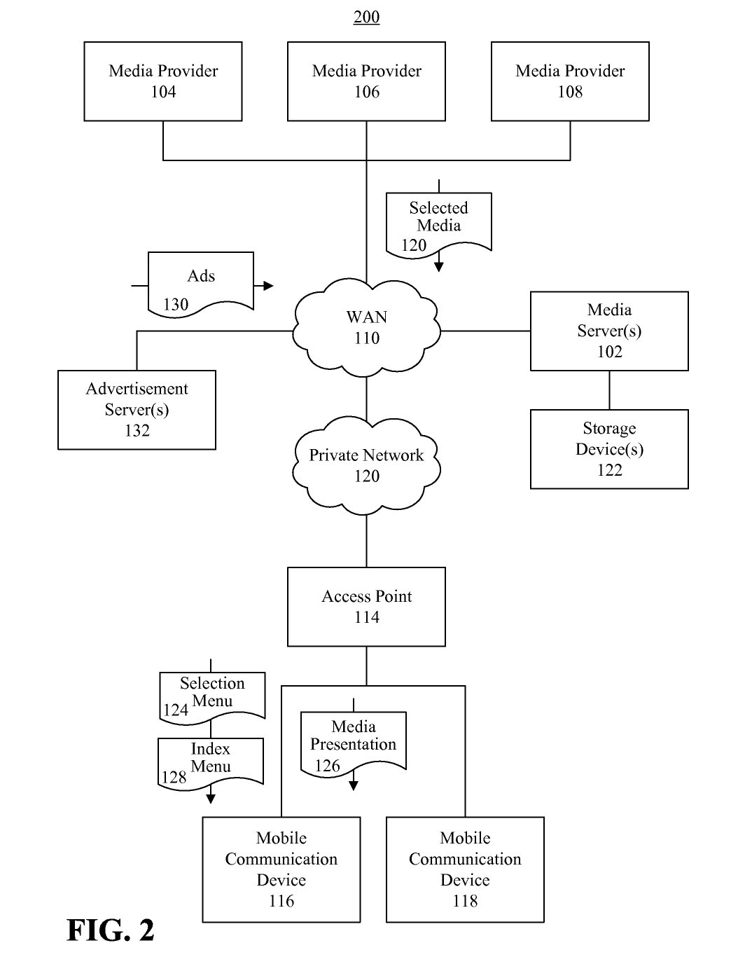

In the example depicted in FIG. 1, the media server 102 and the access point 114 are connected to the same private network 112. For example, the media server 102 can be located in the same establishment as the access point 114. Notwithstanding, the invention is limited in this regard, and additional examples will be discussed herein with respect to FIG. 2.

Referring to FIG. 1, in operation, the media server 102 can collect media 120 from one or more of the media providers 104-108 and store the media 120 to one or more computer readable storage devices (hereinafter “storage devices”) 122. The storage device(s) 122 can be a component of the media server 102, or otherwise communicatively linked to the media server 102. For example, a storage device 122 can be a network-attached storage communicatively linked to the media server 102 via the private network 112.

The media 120 that is collected can be selected according to the interest or needs of users who will access the media via the media server 102. For example, if the media server 102 services a coffee shop, the proprietors of the coffee shop can choose to collect media related to news and current events. If the media server 102 services a sports bar, the proprietors of the sports bar can choose to collect media related to sporting events. Still, any other media can be selected and the invention is not limited to these examples.

To facilitate the selection of media, the media server 102 can be configured to present a convenient user interface through which a system administrators or other authorized user can select the desired media 120. In illustration, a menu of various programs or program categories available for download can be presented within the user interface. The administrator or authorized user can select desired programs or program categories from this menu.

When a particular program or program category is selected, the media server 102 can automatically download and store new media presentations of the selected program or programs within the selected program category as the media presentations become available. Moreover, such selected media can be streamed from the media providers, and stored to the storage device 122, in real time as the individual media presentations are generated. As used herein, the term “real time” means a level of processing responsiveness that a user or system senses as sufficiently immediate for a particular process or determination to be made, or that enables the processor to keep up with some external process.

Further, the media server 102 can be configured to maintain the media 120 on the storage device 122 for a finite period, after which the media 120 is deleted or removed. For example, the media server 102 can be configured to delete individual media presentations minutes, hours, days, weeks, months or years after the media presentations were originally stored. In illustration, media presentations related to news or sporting events may be considered by users as being state more than one day after the corresponding media presentations were originally generated. Accordingly, the media server 102 can be configured to delete such media presentations after one day. On the other hand, television sitcoms may be considered by users as being stale more than one week after the corresponding media presentations were originally generated. Accordingly, the media server 102 can be configured to delete such media presentations after one week. Still, a proprietor may decide to keep other media presentations, such as children's cartoons, indefinitely. In that case, the media server 102 can be configured to maintain such media presentations available on the storage device 122 until an administrator, or other authorized user, selects to remove them.

When a mobile communication device, such as the mobile communication device 116, connects to the private network 112, for example via the access point 114, the media server 102 can detect the presence of the mobile communication device 116 on the private network 112. In response, the media server 102 can push, or otherwise send, information relating to the selected media 120 which is available to the user. For example, the media server 102 can push a selection menu 124 to the mobile communication device 116. In response, the mobile communication device 116 can present the selection menu 124 to the user. In another arrangement, the mobile communication device 116 first can prompt the user to choose whether to view (or listen to) the selection menu 124. If the user chooses not to view (or listen to) the selection menu 124, the selection menu 124 need not be presented. It however, the user chooses to view (or listen to) the selection menu 124, the mobile communication device 116 can present the selection menu 124.

From the selection menu 124, the user can select one or more media presentations 126 from among the selected media 120. For example, the user can choose to view a news broadcast, a sporting event or a television show. The user can also filter the content he will be offered by entering or preselecting various criteria that can be used to adjust the selection offered. The mobile communication device 116 can communicate the user's selection(s) to the media server 102. In response, the media server 102 can begin downloading, streaming, or otherwise providing, the media presentation 126 to the mobile communication device 116 from the storage device 122. In the case in which a user has entered or preselected criteria, the media server 102 can apply the criteria to filter the selected media 120 to facilitate selection of the media presentation 126.

In one aspect of the present invention, the mobile communication device 116 can generate a media presentation session identifier (e.g., a cookie or other identifier) associated with the communication device 116 and/or the user that indicates the media presentation 126 and where playback of the media presentation 126 is currently. For example, the media presentation session identifier can indicate a present location or present time elapsed during playback of the media presentation 126. In one arrangement, the media presentation session identifier can be communicated to the media server 102 periodically. Such period can be defined by seconds, minutes, etc. Further, the media presentation session identifier can be reported in response to certain events, for example when playback of the media presentation is paused or stopped, or playback of the media presentation reaches a certain point, for instance when a scene changes. Regardless of when the media presentation session identifier is generated, the media presentation session identifier can be later processed by the media server 102 and/or the mobile communication device 116 to determine where in the media presentation 126 playback is ceased.

The media presentation session identifier can be retained on the mobile communication device 116 and/or communicated to the media server 102. For example, the media presentation session identifier can be communicated to the media server 102 when generated, when the user closes a presentation session, or communicated at any other suitable time.

When the user again connects to the private network 112, the media presentation session identifier can be processed by the media server 102 to identify the media presentation 126 previously presented to the user, and where playback of the media presentation 126 to the user was ceased. The media server 102 can receive the media presentation session identifier from the mobile communication device 116 or access the media presentation session identifier from a suitable storage location, for example from the storage device 122.

If the user again selects the media presentation 126, the user can be provided an option to begin playback of the media presentation 126 from where the media presentation 126 previously ceased, to begin playback of the media presentation 126 from the beginning, or to begin at playback of the media presentation at another point within the media presentation 126. In illustration, if the user accesses a particular media presentation 126 during a particular visit to an establishment, but leaves the establishment prior to completion of the media presentation 126, when the user again visits the establishment, the media presentation session identifier can be processed by the media server 102 to begin playback of the media presentation 126 from where the user previously left off.

In one embodiment, the media server 102 can be configured to index one or more of the media presentations 126 within the selected media 120 to differentiate portions of the media presentations 126. In illustration, the media server 102 can be configured to index portions of the media presentations 126 based on time segments. For example, each portion of a media presentation 126 can be selected to be a certain length of time. The media server 102 also can be configured to process the media presentations to recognize scene changes and index the individual scenes. The media server 102 can generate metadata tags for the respective portions of the media presentation 126 that is being indexed.

In another embodiment, the media server 102 can perform video recognition and/or audio recognition on the media presentations 126 to identify visual and/or audio features within the media presentations 126. The media server 102 can index the media presentations 126 based on the identified visual and/or audio features. For example, the media server 102 can associate the identified visual and/or audio features with respective portions of the media presentation, and generate metadata tags for the identified visual and/or audio features.

Regardless of how the media presentations 126 are indexed, the individual portions can be tagged with respective metadata tags to facilitate user selection of a specific portion of the media presentation 116. By way of example, in response to a user selecting a particular media presentation 126, the media server 102 can push, or otherwise provide, to the mobile communication device 116 an index menu 128 corresponding to the media presentation 126. Via the index menu 128, the user can select a portion of the media presentation 126 to be presented on the mobile communication device 116. For instance, the index menu 128 can present the metadata tags used to tag the respective portions of the media presentation 126. In addition to, or in lieu of, presenting the metadata tags, the index menu 128 can present still images corresponding to the different portions of the media presentation 126. The metadata tags and/or the still images can be configured to be user selectable to enable the user to navigate to a specific portion of the media presentation 126. In another arrangement, user selectable icons or buttons can be presented in the index menu 128 proximate to the metadata tags and/or the stilt images to enable the user to navigate to a specific portion of the media presentation 126.

In another embodiment, the media server 102 can configure the index menu 128 to receive at least one search term from a user. Upon receiving a search term, the mobile communication device 116 can communicate the search term to the media server 102, which can match the search term to at least one of the metadata tags to facilitate selection of the specific portion of the media presentation 116. A match need not be an exact match to a particular search term. For example, the media processor can identify synonyms or other terms that may be related, and identify a match based on such identification.

In response to matching the search term to a metadata tag identifying a portion of the media presentation 126, the media server 102 can push that portion to the communication device 116 to be presented to the user. If metadata tags for multiple portions of the media presentation 126 match the search term, the media server can update the index menu 128 to present indicators (e.g., still images and/or the metadata tags) for the respective portions. The user then can select an indicator corresponding to the portion of the media presentation the user wishes to be delivered to the mobile communication device 116.

In another aspect of the present invention, the media server 102 can transcode the selected media 120. In illustration, audio/video media oftentimes is communicated in a Moving Picture Experts Group (MPEG) format, for example in an MPEG-2 or MPEG-4 format. When audio/video media is encoded in an MPEG format, frames usually are grouped into a group of pictures (GOP). Each GOP typically contains one intra frame (1-frame), a number of predicted frames (P-tiames) and a number of bi-directional frames (B-frames). An I-frame can be fully decompressed without any reference to frames that precede or follow the I-frame. P-frames are encoded from a predicted picture based on the closest preceding I-frame or P-frame. Accordingly, P-frames typically contain less data than an I-frame. B-frames are encoded from an interpolation of succeeding and preceding reference frames. The reference frames can be either I-frames or P-frames. B-frames typically contain the least amount of data.

Because P-frames and B-frames MPEG formatted audio/video media depend on other frames, MPEG media is especially susceptible to noise and interference on the communication link, for example when being wirelessly transmitted. For example, if noise/interference causes data for an I-frame to be lost, not only will the I-frame have resulting degradation of the picture, but the remaining P-frames and B-frames in the GOP, which depend directly or indirectly on the I-frame, also will have degradation.

Video degradation is undesirable, and can be an issue if the access point 114 wirelessly communicates with the mobile communication devices 116, 118 when the establishment in which the access point 114 is located is in an environment with significant levels of RE noise and/or interference. To reduce the impact of video degradation, the media server 102 can decode the selected media 120, and re-encode the selected media 120 to provide smaller GOP structures (e.g., using MPEG-4). For example, if the media providers 104-108 provide the selected media 120 with fifteen frame GOP structures, the media server 102 can transcode the selected media 120 to have GOP structures with five frames, ten frames, or any other desired GOP size. Accordingly, degradation of the media presentations 126 due to RF noise and interference will be reduced. In other words, rather than fifteen frames being affected by an RF noise spike, five or ten frames only may be affected. As used herein, to “transcode media” means to convert media from a first encoding scheme to a second encoding scheme that is different from the first encoding scheme. For example the media can be decoded from the first encoding scheme and re-encoded using the second encoding scheme. The transcoding can occur in real time, though this need not be the case.

In another aspect of the present invention, the system 100 can be configured to generate revenue to the proprietor of the establishment. For example, the media server 102 can be configured to provide to the mobile communication devices 116, 118 access to media presentations 126 on a fee basis. In illustration, the selection menu 124 can indicate media presentations 126 for which a fee is required to access. If a user selects to view such a media presentation 126, the selection menu 124, or another view presented on the mobile station 116, can prompt the user to enter payment information in order to access the media presentation, for example by entering credit card or debit card information. Such information can be communicated from the mobile communication device 116 to the media server 102 for processing. When the payment information is verified, the media server 102 can download, stream, or otherwise provide, the media presentation 126 to the mobile communication device 116 for presentation. The payment information (e.g., credit card or debit card information) can be stored by the media server 102, or another suitable server, so that such payment information will be available for future use by the user. Such an arrangement can facilitate use of the system 100 by repeat customers.

In another embodiment, rather than requiring the user to enter credit card or debit card information, the fee for accessing the media presentation 126 can be added to an invoice or tab associated with the user. For example, in a restaurant setting, if a user selects to view such a media presentation 126, the selection menu 124, or another view presented on the mobile station 116, can prompt the user to enter a table number or name. Such information can be communicated from the mobile communication device 116 to the media server 102. The media server can communicate with an electronic register system (not shown) to add the fee for the media presentation 126 to the users tab. For example, the fee for the media presentation 126 can be displayed on a invoice (or check) delivered to the user at the end of a meal.

In another aspect of the present invention, the media server 102 can be configured to provide with the media presentation 126 one or more advertisements 130. The advertisements 130 can be videos that are communicated to the mobile communication device 116 and presented prior to the media presentation 126, between portions of the media presentation 126, or presented in an area of a display on the mobile communication device 116 that is different from an area in which the media presentation 126 is presented. The advertisements 130 also can be still images or animation (e.g., ActionScript) presented on the display on the mobile communication device 116.

The media server 102 can be configured to retrieve the advertisements 130 from the storage device 122 or another storage location, for example from one or more advertisement servers 132. Further, the media server 102 can be configured to track the presentation of the advertisements 130. For example, the media server 102 can track which advertisements 130 are presented and when they are presented, Data (e.g., records) of such tracking can be generated and maintained in a data table, or another suitable data structure. In another arrangement, the advertisement server 132 can track presentation of the advertisements 130. For example, the advertisement can maintain records or other data corresponding to the media server 102 accessing advertisements 130 from the advertisement server 132. The data can he processed to determine an amount of revenue due to the proprietor of the establishment as compensation for presenting the advertisements.

FIG. 2 is a block diagram illustrating a system 200 for delivering media to mobile communication devices in accordance with another embodiment of the present invention. The system 200 is similar to the system 100 of FIG. 1 and like numbers have been used to refer to the same items. However, rather than being connected directly to the access point 114 via the private network 120, the media server(s) 102 can be communicatively linked to the private network 120, and thus the access point 114, via the WAN 110. In this example, the WAN 110 can provide a communication medium in which the media server(s) 102 connect to the private network 120. In one aspect, the media server 102 can connect to the private network 120 via a virtual private network (VPN). Again, the storage device(s) 122 can be a component of the media server 102, or otherwise communicatively linked to the media server 102.

In the system 200, the media server can be located remotely with respect to the establishment in which the private network 120 is located. For example, if a particular company manages a chain of establishments, the media server(s) 102 can be located at a central location, for example within a data service center, at the corporate headquarters, etc. Accordingly, the media server(s) can be more easily centrally managed.

The functionality of the system 200 to deliver media the mobile communication devices 116, 118 can be substantially similar to the functionality described with respect to the system 100 of FIG. 1.

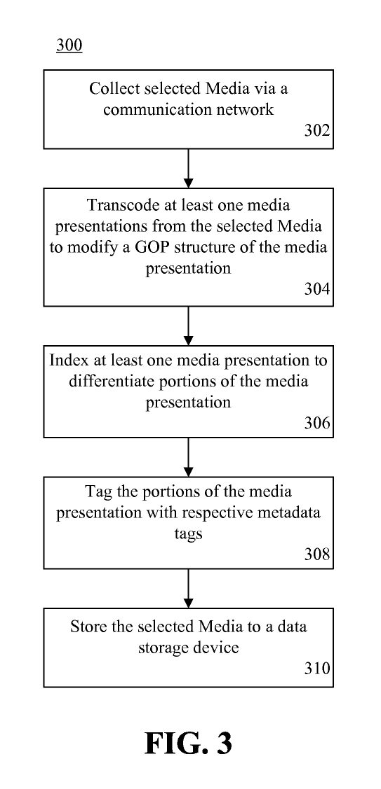

FIG. 3 is a flow chart illustrating a method 300 of delivering media to mobile communication devices in accordance with an embodiment of the present invention. At step 302, selected media can be collected via a communication network. At step 304 at least one media presentation from the selected media can be transcoded to modify a GOP structure of the media presentation. At step 306, at least at least one media presentation from the selected media can be indexed to differentiate different portions of the media presentation. At step 308, the portions of the media presentation can be tagged with respective metadata tags. As noted, the metadata tags can be generated based on video and/or audio recognition applied to the media presentation, but the invention is not limited in this regard. At step 310, the selected media can be stored to a storage device.

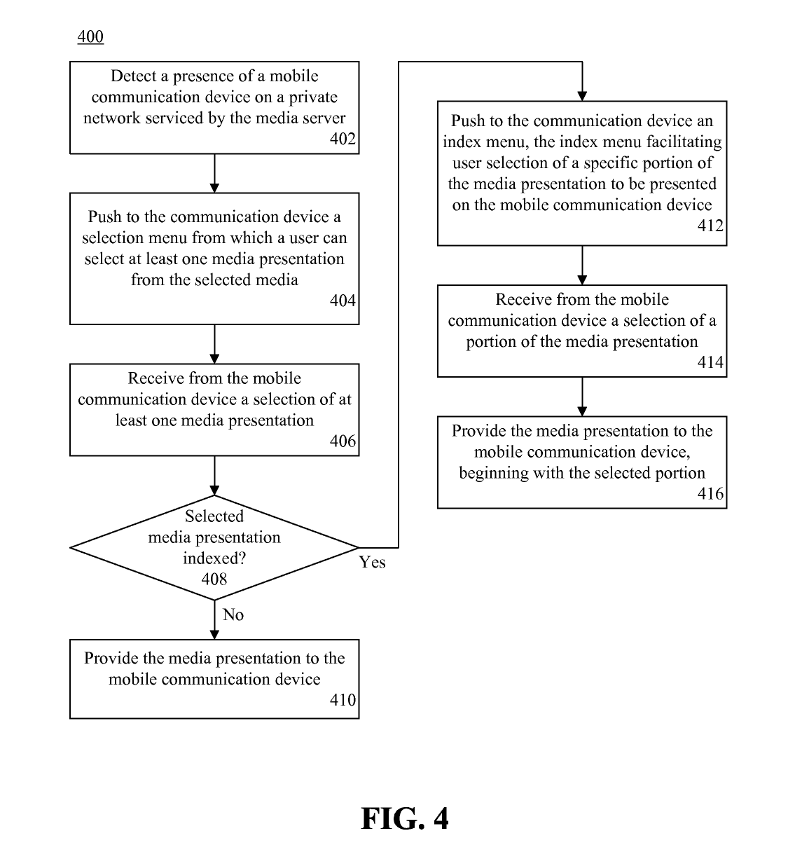

FIG. 4 is a flow chart illustrating a method 400 of delivering media to mobile communication devices in accordance with an embodiment of the present invention. At step 402, a presence of a mobile communication device on a private network serviced by the media server can be detected by the media server. At step 404, the media server can push to the communication device a selection menu from which a user can select at least one media presentation from the selected media. At step 406, the media server can receive from the mobile communication device a selection of at least one media presentation.

Referring to decision box 408, if the selected media presentation is not indexed, at step 410 the media presentation can be provided to the mobile communication device for presentation to the user. Utile selected media presentation is indexed, at step 412 the media server can push to the communication device an index menu, the index menu facilitating user selection of a specific portion of the media presentation to be presented on the mobile communication device. At step 414, the media server can receive from the mobile communication device a selection of a portion of the media presentation. At step 416, the media server can provide the media presentation to the mobile communication device, beginning with the selected portion.

As noted, the user can be charged a fee to access the media presentation. Further, one or more revenue generating advertisements can be provided to the mobile communication device for presentation to the user.

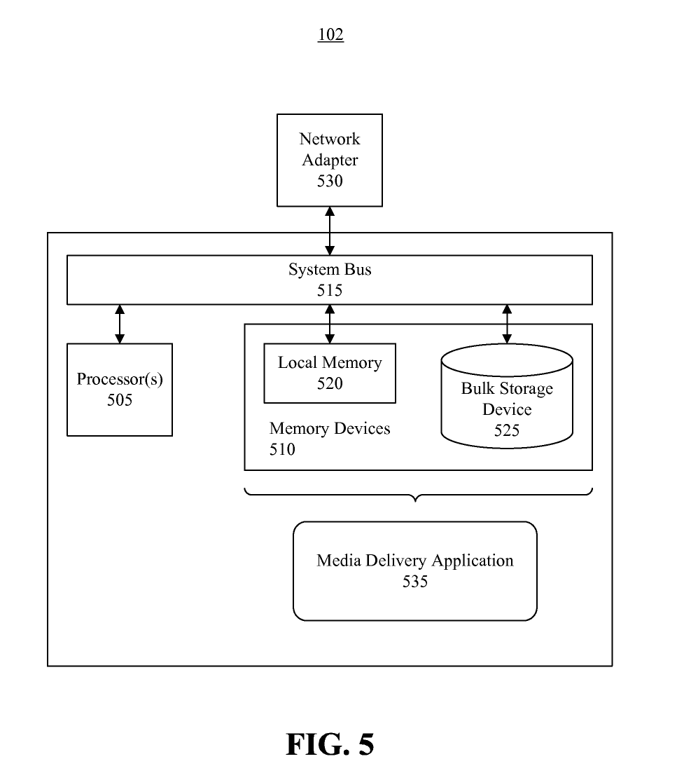

FIG. 5 is block diagram illustrating a media server 102 in accordance with one embodiment of the present invention. The media server 102 can include one or more processors 505 coupled to memory elements 510 through a system bus 515. As such, the media server 102 can store program code within memory elements 510. The processor(s) 505 can execute the program code accessed from the memory elements 510 via the system bus 515. In one aspect, for example, the media server 102 can be implemented as computer that is suitable for storing and/or executing program code. It should be appreciated, however, that media server 102 can be implemented in the form of any system or systems comprising at least one processor and memory that is capable of performing the functions described within this specification.

The memory elements 510 can include one or more physical memory devices such as, for example, local memory 520 and one or more bulk storage devices 525. Local memory 520 refers to random access memory or other non-persistent memory device(s) generally used during actual execution of the program code. Bulk storage device(s) 525 can be implemented as one or more computer readable storage devices, examples of include, but are not limited to, hard drives, solid state drives, or other persistent storage devices. The media server 102 also can include one or more cache memories (not shown) that provide temporary storage of at least some program code in order to reduce the number of times program code must be retrieved from bulk storage device 525 during execution.

A network adapter 530 can be coupled to the media server 102 to enable the media server 102 to become coupled to other systems, computer systems, and/or remote storage devices through intervening private or public networks. Modems, cable modems, and Ethernet cards are examples of different types of network adapters that can be used with media server 102. The network adapter 530 can be coupled to the media server 102 either directly or through intervening I/O controller.

As pictured in FIG. 5, the memory elements 510 can store a media delivery application 535. The media delivery application can be executed by the processor(s) 505 to implement the processes and functionality performed by the media server 102 as described herein.

Like numbers have been used to refer to the same items throughout this specification. The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, hut do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of delivering media to mobile communication devices, the method comprising:
via a media server, collecting selected media via a communication network;
storing the selected media to a computer readable storage device;
detecting a presence of a mobile communication device on a private network serviced by the media server;
sending to the mobile communication device information relating to the selected media; and
responsive to receiving from the mobile communication device a selection of at least one media presentation from the selected media, providing the media presentation to the mobile communication device.

2. The method of claim 1, further comprising:
indexing the media presentation to differentiate portions of the media presentation;
wherein providing the media presentation to the mobile communication device comprises providing an index menu for the media presentation, the index menu facilitating user selection of a specific portion of the media presentation to be presented on the mobile communication device.

3. The method of claim 2, further comprising:
tagging the portions of the media presentation with respective metadata tags; and
configuring the index menu to present the metadata tags to a user to facilitate selection of the specific portion of the media presentation.

4. The method of claim 2, further comprising:
tagging the portions of the media presentation with respective metadata tags; and
configuring the index menu to receive at least one search term from a user and match the search term to at least one of the metadata tags to facilitate selection of the specific portion of the media presentation.

5. The method of claim 2, further comprising:
performing video recognition on the media presentation to identify visual features within the media presentation;
associating the identified visual features with respective portions of the media presentation;
generating metadata tags for the identified visual features; and
tagging the portions of the media presentation with respective ones of the metadata tags.

6. The method of claim 2, further comprising:
performing audio recognition on the media presentation to identify audio features within the media presentation;
associating the identified audio features with respective portions of the media presentation;
generating metadata tags for the identified audio features; and
tagging the portions of the media presentation with respective ones of the metadata tags.

7. The method of claim 1, further comprising:
transcoding the media presentation to modify a group of pictures (GOP) structure of the media presentation;
wherein storing the selected media to the computer readable storage device comprises storing the media presentation with the modified GOP structure.

8. The method of claim 1, further comprising:
prompting a user of the mobile communication device to enter payment information in order to access the media presentation.

9. The method of claim 1, further comprising:
responsive to receiving from the mobile communication device a selection of at least one media presentation from the selected media, adding a fee for accessing the media presentation to an invoice associated with a user of the mobile communication device.

10. The method of claim 1, further comprising:
providing with the media presentation at least one advertisement; and
generating data corresponding to the presentation of the at least one advertisement, the data being processed to determine an amount of revenue due as compensation for presenting the at least one advertisement.

11. The method of claim 1, wherein:
receiving from the mobile communication device the selection of at least one media presentation from the selected media comprises receiving a media presentation session identifier indicating the selected media presentation and where in the media presentation a previous playback of the media presentation to the user ceased; and
providing the media presentation to the mobile communication device comprises beginning a new playback of the media presentation from where the previous playback of the media presentation ceased.

12. A computer program product comprising:
a first computer readable storage device having stored thereon computer readable program code that, when executed by a system comprising a processor and a memory, delivers media to mobile communication devices, the first computer readable storage device comprising:
computer readable program code that collects selected media via a communication network;
computer readable program code that stores the selected media to the first computer readable storage device or a second computer readable storage device;
computer readable program code that detects a presence of a mobile communication device on a private network serviced by the media server;
computer readable program code that sends to the mobile communication device information relating to the selected media; and
computer readable program code that, responsive to receiving from the mobile communication device a selection of at least one media presentation from the selected media, provides the media presentation to the mobile communication device.

13. The computer program product of claim 12, the first computer readable storage device further comprising:
computer readable program code that indexes the media presentation to differentiate portions of the media presentation;
wherein the computer readable program code that provides the media presentation to the mobile communication device comprises computer readable program code that provides an index menu for the media presentation, the index menu facilitating user selection of a specific portion of the media presentation to be presented on the mobile communication device.

14. The computer program product of claim 13, the first computer readable storage device further comprising:
computer readable program code that tags the portions of the media presentation with respective metadata tags; and
computer readable program code that configures the index menu to present the metadata tags to a user to facilitate selection of the specific portion of the media presentation.

15. The computer program product of claim 13, the first computer readable storage device further comprising:
computer readable program code that tags the portions of the media presentation with respective metadata tags; and
computer readable program code that configures the index menu to receive at least one search term from a user and match the search term to at least one of the metadata tags to facilitate selection of the specific portion of the media presentation.

16. The computer program product of claim 13, the first computer readable storage device further comprising:
computer readable program code that performs video recognition on the media presentation to identify visual features within the media presentation;
computer readable program code that associates the identified visual features with respective portions of the media presentation;
computer readable program code that generates metadata tags for the identified visual features; and
computer readable program code that tags the portions of the media presentation with respective ones of the metadata tags.

17. The computer program product of claim 13, the first computer readable storage device further comprising:
computer readable program code that performs audio recognition on the media presentation to identify audio features within the media presentation;
computer readable program code that associates the identified audio features with respective portions of the media presentation;
computer readable program code that generates metadata tags for the identified audio features; and
computer readable program code that tags the portions of the media presentation with respective ones of the metadata tags.

18. The computer program product of claim 12, the first computer readable storage device further comprising:
computer readable program code that transcodes the media presentation to modify a group of pictures (GOP) structure of the media presentation;
wherein the computer readable program code that stores the selected media to the first or second computer readable storage device comprises computer readable program code that stores the media presentation with the modified GOP structure.

19. The computer program product of claim 12, the first computer readable storage device further comprising:
computer readable program code that prompts a user of the mobile communication device to enter payment information in order to access the media presentation.

20. The computer program product of claim 12, the first computer readable storage device further comprising:
computer readable program code that, responsive to receiving from the mobile communication device a selection of at least one media presentation from the selected media, adds a fee for accessing the media presentation to an invoice associated with a user of the mobile communication device.

21. The computer program product of claim 12, the first computer readable storage device further comprising:
computer readable program code that provides with the media presentation at least one advertisement; and
computer readable program code that generates data corresponding to the presentation of the at least one advertisement, the data being processed to determine an amount of revenue due as compensation for presenting the at least one advertisement.

22. The computer program product of claim 12, wherein:
the computer-readable program code that receives from the mobile communication device the selection of at least one media presentation from the selected media comprises computer-readable program code that receives a media presentation session identifier indicating the selected media presentation and where in the media presentation a previous playback of the media presentation to the user ceased; and
the computer-readable program code that provides the media presentation to the mobile communication device comprises computer-readable program code that begins a new playback of the media presentation from where the previous playback of the media presentation ceased.

23. A media server that delivers media to mobile communication devices, the media server comprising:
at least one memory device; and
at least one processor;
wherein the processor is operable to:
collect selected media via a communication network;
store the selected media to a computer readable storage device;
detect a presence of a mobile communication device on a private network serviced by the media server;
send to the mobile communication device information relating to the selected media; and
responsive to receiving from the mobile communication device a selection of at least one media presentation from the selected media, provide the media presentation to the mobile communication device.
